(19) United States
(12) Patent Application Publication
(10) Pub. No.: US 2023/0334534 A1
(43) Pub. Date: Oct. 19, 2023

(54) COMBINING ONLINE USER ACTIVITY WITH ADVERTISEMENTS FOR DISTRIBUTION ON A DECENTRALIZED NETWORK

(71) Applicant: Neal Harley Landers, Ball Ground, GA (US)

(72) Inventor: Neal Harley Landers, Ball Ground, GA (US)

(21) Appl. No.: 18/321,101

(22) Filed: May 22, 2023

Related U.S. Application Data
(63) Continuation-in-part of application No. 17/941,598, filed on Sep. 9, 2022.
(60) Provisional application No. 63/243,183, filed on Sep. 12, 2021.

(51) Int. Cl. G06Q 30/0241

(52) U.S. Cl. CPC G06Q 30/0277; G06Q 30/0276

(57) ABSTRACT

Systems and methods are provided for combining advertising with media content sharing and other user experience apps for distributing ads and dispersing ad revenue with content creators. In one implementation, an end user device includes a processing device, a memory device, and a network interface that enables communication over a network, such as a decentralized network. The memory device is configured to store one or more user experience applications and an advertisement handling application. The advertisement handling application includes instructions enabling the processing device to monitor user activity output based on operation of the one or more user experience applications. The instructions further enable the processing device to obtain an advertisement and secure the advertisement to the user activity output using blockchain technologies to generate a secured data packet. Also, the instructions enable the processing device to distribute the secured data packet over the decentralized network via the network interface.

### CROSS-REFERENCE TO RELATED APPLICATION

This application is a Continuation-In-Part (CIP) of U.S. patent application Ser. No. 17/941,598, filed Sep. 9, 2022, and entitled, “Embedding Advertisements into Digital Media Content Shared within a Distributed System,” which claims the benefit under 35 U.S.C. § 119 of U.S. Provisional Application No. 63/243,183, filed Sep. 12, 2021, wherein the contents of each are incorporated by reference herein.

### TECHNICAL FIELD

The present disclosure generally relates to online media content sharing. More particularly, the present disclosure relates to systems and methods for placing advertisements within media content and financially rewarding content creators.

### BACKGROUND

For years, businesses have turned to advertising to endorse their products, services, brands, etc. Advertisements can be presented to an audience in a number of ways, such as in printed form (e.g., in newspapers, magazines, flyers, etc.), audible form (e.g., over the radio), and in audio-visual form (e.g., videos displayed on television, computers, etc.). Despite the numerous ways that businesses currently advertise, they still strive to find new ways to distribute advertisements to an audience.

At the same time, social media sites are widespread and are an integral part of the lives of many people. Typically, social media platforms are controlled in a centralized manner. However, with the advent of blockchain and Non-Fungible Tokens (NFTs) in online gaming and other online experiences, there is a need for a distributed (e.g., decentralized) network or system that is able to combine advertising within these media content environments.

### SUMMARY

The present disclosure describes various implementations of systems and methods for embedding ads in media content and providing portions of ad revenue to the media content providers or creators. According to one implementation, a media and ad sharing system may include a plurality of end user devices configured to create and share digital media content and to view digital media content from other end user devices. The media and ad sharing system also includes a plurality of advertiser devices configured to purchase virtual ad space for distributing ads within one or more user experience applications of the end user devices. Also, the media and ad sharing system includes a control system configured to automatically exchange cryptocurrency payments among the advertiser devices and the end user devices that share digital media content.

The control system, according to some implementations, may include a finance management module configured to use blockchain to store Non-Fungible Tokens (NFTs) and advertisements. The control system may be configured to categorize advertisements with respect to subject matter and match the ads with one or more corresponding user experience applications. In some implementations, each end user device may be configured to set multiple selectable groups to which digital media content is shared.

Furthermore, each end user device may be configured with an influencer contact module allowing the user to contact an influencer for sharing content. An end user device associated with the influencer may be configured to receive payment cryptocurrency when the influencer reviews the content. The end user device, in some cases, may be configured to upload broadcast-type communication for reporting local news. Also, the control system may be configured to create smart contracts, blockchain files, or NFTs for defining an originator of digital media content.

According to another implementation, the present disclosure provides a method that includes the step of monitoring user activity output based on operation of the one or more user experience applications. The method also includes obtaining an advertisement and then securing the advertisement to the user activity output using one or more blockchain technologies to generate a secured data packet. Also, the method includes distributing the secured data packet over the decentralized network via the network interface. In some embodiments, the method may be performed by an end user device.

In some embodiments, the decentralized network may be a Web3 network, which may be configured to maintain user privacy. The method may also include the step of utilizing a content and advertisement distribution program associated with a remote advertisement agency platform configured to create, purchase, and track advertisements. The remote advertisement agency platform, for instance, may be configured to establish a cryptocurrency coin system in which coins are exchanged based on a) an identification of one or more ads created, b) an identification of ad spaces where the one or more ads are shown, c) an identification of sales transactions where the one or more ads were bought, d) a record of the distribution of the one or more ads in the ad spaces, and/or e) a report that the one or more ads were shown and viewed.

The end user device executing the method may include a network interface configured to communicate over Transmission Control Protocol and Internet Protocol (TCP/IP), where the secured data packet generated using the one or more blockchain technologies is communicated over TCP/IP. At least one of the user experience applications and advertisement handling application, for example, may include one or more programs for enabling a) the creation of ads, b) the creation of media content, c) the playing of online games, and/or d) the participation in online wagering. The user experience applications and advertisement handling application may include at least a financial management module configured to conduct financial transactions related to the one or more applications programs for enabling a) the creation of ads, b) the creation of media content, c) the playing of online games, and/or d) the participation in online wagering. Also, the end user device executing the method may include a display device for displaying at least digital media content and advertisements. The end user device may be a personal computer, a laptop computer, a tablet computer, a mobile phone, or a Virtual Reality (VR) system. The user activity output may include creating and sharing digital media content.

### BRIEF DESCRIPTION OF THE DRAWINGS

The present disclosure is illustrated and described herein with reference to the accompanying drawings. Like reference numbers are used throughout the drawings to denote corresponding features or components, as appropriate. The features illustrated in the drawings are intended to emphasize the general principles of the present disclosure and are not necessarily drawn to scale.

FIG. 1 is a block diagram illustrating a media and ad sharing system, according to various embodiments of the present disclosure.

FIG. 2 is a block diagram illustrating the control system shown in FIG. 1, according to various embodiments.

FIG. 3 is a block diagram illustrating the content and advertisement distribution program shown in FIG. 2, according to various embodiments.

FIG. 4 is a block diagram illustrating the ad management module shown in FIG. 3, according to various embodiments.

FIG. 5 is a block diagram illustrating one of the end user devices shown in FIG. 1, according to various embodiments.

FIG. 6 is a block diagram illustrating the user experience app(s) shown in FIG. 5, according to various embodiments.

### DETAILED DESCRIPTION

The present disclosure describes systems and methods for enabling advertisers to create advertisements for delivery throughout a distributed network or distributed computer system (e.g., the Internet). In some embodiments, the distributed network is a decentralized network or decentralized system that allows sharing of data (e.g., media content, advertisements, finances, etc.) among a number of users without centralized control. The present disclosure also enables end users (e.g., using computers, mobile phones, etc.) to interact with others by creating, sharing, and viewing digital media content (e.g., pictures, texts, videos, posts, etc.). For example, this process of sharing media content may be part of one or more newly developed or already existing social media platforms on the Internet or other distributed networks and systems.

More particularly, the systems and methods of the present disclosure are configured to combine or aggregate the advertisement systems with the media content sharing systems. With advertisers paying to have their ads distributed in a way in which multiple people can see and/or hear the ads, the media content creators may also be able to financially benefit from posting content on the media content systems. In this way, by embedding ads along with media content, multiple end users will not only view and/or comment on the various posts but will also be exposed to the ads. In addition to social media sharing, the present disclosure also enables online users to participate in other types of user experiences, such as online gaming environments, buying/selling environments, dating environments, wagering environments, and other types of online experiences.

In the social media content sharing environments (and other user experience environments), communications and online actions can be enabled using a suitable type of secure yet publicly accessible digital ledger technology (e.g., blockchain). For instance, blockchain is used for securely recording and sharing data (e.g., cryptocurrency) in a decentralized fashion. In particular, by aggregating advertisement systems with the media content sharing systems, the present disclosure is able to securely determine the originator of certain media content (particularly content that goes “viral”) and financially reward the originator. For example, advertisements may be embedded in various “virtual spaces” (e.g., virtual real estate) in a system that strategically embeds the advertisements in these spaces for viewing by other end users who may “consume” (or view) the ads along with the media content. It may also be noted that the security measures used in the sharing of ads and social media content may be performed using blockchain technology and/or the security systems and methods described with respect to the above-referenced commonly-owned patents and publications.

There has thus been outlined, rather broadly, the features of the present disclosure in order that the detailed description may be better understood, and in order that the present contribution to the art may be better appreciated. There are additional features of the various embodiments that will be described herein. It is to be understood that the present disclosure is not limited to the details of construction and to the arrangements of the components set forth in the following description or illustrated in the drawings. Rather, the embodiments of the present disclosure may be capable of other implementations and configurations and may be practiced or carried out in various ways. Also, it is to be understood that the phraseology and terminology employed are for the purpose of description and should not be regarded as limiting.

As such, those skilled in the art will appreciate that the inventive conception, upon which this disclosure is based, may readily be utilized as a basis for the designing of other structures, methods, and systems for carrying out the several purposes described in the present disclosure. Those skilled in the art will understand that the embodiments may include various equivalent constructions insofar as they do not depart from the spirit and scope of the present invention. Additional aspects and advantages of the present disclosure will be apparent from the following detailed description of exemplary embodiments which are illustrated in the accompanying drawings.

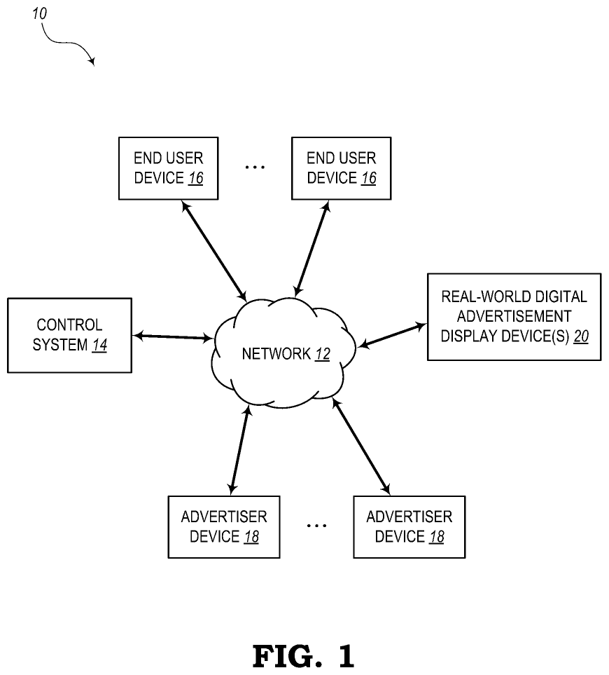

FIG. 1 is a block diagram illustrating an embodiment of a media and ad sharing system 10 for enabling both the sharing of media content and distributing advertisements (ads). Also, the functionality of sharing media content can be financially aggregated with the functionality of distributing ads. In other words, advertisers may pay a fee to distribute their ads to users or consumers of the media and ad sharing system 10 and the users are able to receive funds for sharing original media content. For example, the media and ad sharing system 10 may be configured to determine the “originator” of media content based on tamperproof blockchain records. Therefore, based a user providing more interesting and more frequently viewed content, the user can make more money and the advertisers can present more ads to more people.

As shown in FIG. 1, the media and ad sharing system 10 may be configured to run over a network 12, which may include the Internet or other public Wide Area Network (WAN), a private network, a centralized network, a decentralized network, a hybrid centralized/decentralized network, a Web3 network, a distributed system, a blockchain network, and/or other networks, sub-networks, and communication systems. The media and ad sharing system 10 also includes a control system 14 configured to manage or control operations on the media and ad sharing system 10 with respect to the functionality of sharing media content and distributing advertisements as described in the present disclosure. In some embodiments, the media and ad sharing system 10 may be a decentralized system, whereby the network 12 is a distributed system for enabling communication between various devices along various possible paths. For example, the decentralized network/system may have a mesh-type network architecture and the control system 14 may include multiple servers and decentralized elements for enabling communication. In other embodiments, the media and ad sharing system 10 may be configured as a centralized system in which the control system 14 is a central controller.

The network 12 may be configured to operate using any number of suitable communication protocols for communicating data packets throughout the network 12. For example, the network 12 may use Transmission Control Protocol and Internet Protocol (TCP/IP), the Open Systems Interconnection (OSI) model, or other networking models as a communication framework on which the media and ad sharing system 10 may operate. Furthermore, to maintain the decentralization aspects of the network 12, blockchain technologies may be used on top of TCP/IP.

Furthermore, the media and ad sharing system 10 may include a plurality of end user devices 16 for allowing users to create and post new media content and/or to view media content posted by other users. For example, each of the end user devices 16 may be a personal computer, a laptop computer, a tablet computer, a mobile phone, a smart phone, or other suitable processor-based device. Also, the media and ad sharing system 10 may include a plurality of advertiser devices 18 for allowing advertisers to create ads for presentation on the end user devices 16 along with the shared media content. The control system 14 may be configured to enforce certain predetermined rules regarding how the ads are added to or embedded within the media content. For example, the control system 14 may allow one ad to be displayed whenever at least a certain number of user posts are displayed or viewed. The creation of advertisements and the development of advertisement strategies may include the same or similar features as described in commonly-owned U.S. Pat. No. 9,076,161, entitled “System for Printing Advertisements on a Ticket,” issued Jul. 7, 2015; U.S. Pat. No. 9,836,763, entitled “Printing, Displaying, and Etching Advertisements on Various Media,” issued Dec. 5, 2017; and pending application Ser. No. 15/829,976, entitled “Creating an Advertisement Strategy,” published as Pub. No. 2019/0172093 on Jun. 6, 2019; the content of each patent or publication being incorporated by reference herein.

It may be noted that the action of “viewing” digital media content may be the result of the control system 14 pushing the media content uploaded by one user onto the viewing screen of end user devices 16 falling within a specific group or groups of users related to the originating user in some way. For example, the viewing screen on the end user devices 16 may be a computer screen, a monitor, a mobile phone display screen, a tablet display screen, a Virtual Reality (VR) headset, or other suitable display device. Also, the users may “view” the media content by downloading, streaming, consuming, looking at, reading, listening to, sensing, perceiving, or experiencing the media content in some physical way, whereby the media content may include text, pictures, video, sounds, etc. Also, the users may be considered to “view” the media content if they scroll to, scroll over, run a program, stream data, etc. with respect to the presented media content. Also, the action of publishing media content (e.g., by the originating user) may also refer to creating, originating, posting, uploading, and/or transferring digital media content that can be viewed by others, where the media content may include text, pictures, video, etc.

In some embodiments, it may be considered that users fulfill a deeper interest in the media content if they respond to the content in some way, such as by “liking” the content, clicking on an icon associated with media content, adding a comment with respect to the content, etc. In some embodiments, the originating user may be rewarded more for users taking a greater interest, which may show that the viewing users are more engrossed in the viewing experience and likely may be more receptive to being influenced by any ads that are being displayed.

In some embodiments, the media and ad sharing system 10 may optionally include one or more real-world digital advertisement display devices 20. These display devices 20 may include, for example, digital billboards that can display the ads created by the advertiser devices 18. These display devices 20 (e.g., digital billboards) may be changeable, as described in more detail below.

Also, in some embodiments, the media and ad sharing system 10 may also include one or more Memory-as-a-Service (MaaS) devices. For example, the MaaS devices may be configured as databases, data stores, etc. used in conjunction with any computing device (e.g., control system 14, end user devices 16, advertiser devices 18, etc.) that may be connected to the network 12, where these computing devices may be configured to store media content that is shared in the media and ad sharing system 10. Therefore, if users wish to save certain media content that they have shared with others, this media content can be stored in the MaaS devices. In some embodiments, this service may require a cost to the originating user and/or may be paid by one or more other users who might wish that any special or significant media content is saved, such as if one or more people believe that the content is worth saving. Otherwise, media content may be stored on the individual end user devices 16, as memory is available, or may be deleted after a certain amount of time. According to some embodiments, the users of one or more end user devices 16 may wish to provide storage services (e.g., similar to the function of the MaaS devices) and receive a fee for providing this data storage service. Also, the control system 14 and/or advertising devices 18 may also act as a MaaS device for storing media content long-term.

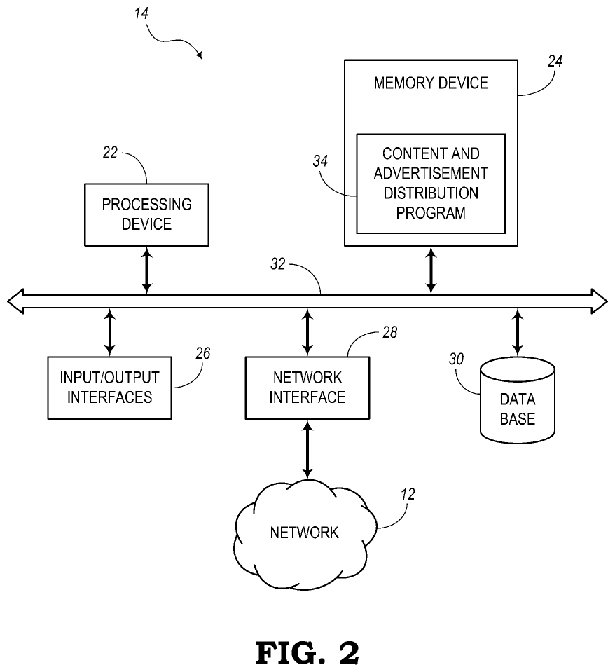

FIG. 2 is a block diagram illustrating an embodiment of the control system 14 shown in FIG. 1 for controlling various operations of the media and ad sharing system 10 in a centralized or decentralized architecture. In this embodiment, the control system 14 may be a digital computing device that generally includes a processing device 22, a memory device 24, Input/Output (I/O) interfaces 26, a network interface 28, and a database 30. It should be appreciated that FIG. 2 depicts the control system 14 in a simplified manner, where some embodiments may include additional components and suitably configured processing logic to support known or conventional operating features. The components (i.e., 22, 24, 26, 28, 30) may be communicatively coupled via a local interface 32. The local interface 32 may include, for example, one or more buses or other wired or wireless connections. The local interface 32 may also include controllers, buffers, caches, drivers, repeaters, receivers, among other elements, to enable communication. Further, the local interface 32 may include address, control, and/or data connections to enable appropriate communications among the components 22, 24, 26, 28, 30.

It should be appreciated that the processing device 22, according to some embodiments, may include or utilize one or more generic or specialized processors (e.g., microprocessors, CPUs, Digital Signal Processors (DSPs), Network Processors (NPs), Network Processing Units (NPUs), Graphics Processing Units (GPUs), Field Programmable Gate Arrays (FPGAs), semiconductor-based devices, chips, and the like). The processing device 22 may also include or utilize stored program instructions (e.g., stored in hardware, software, and/or firmware) for control of the control system 14 by executing the program instructions to implement some or all of the functions of the systems and methods described herein. Alternatively, some or all functions may be implemented by a state machine that may not necessarily include stored program instructions, may be implemented in one or more Application Specific Integrated Circuits (ASICs), and/or may include functions that can be implemented as custom logic or circuitry. Of course, a combination of the aforementioned approaches may be used. For some of the embodiments described herein, a corresponding device in hardware (and optionally with software, firmware, and combinations thereof) can be referred to as “circuitry” or “logic” that is “configured to” or “adapted to” perform a set of operations, steps, methods, processes, algorithms, functions, techniques, etc., on digital and/or analog signals as described herein with respect to various embodiments.

The memory device 24 may include volatile memory elements (e.g., Random Access Memory (RAM), Dynamic RAM (DRAM), Synchronous DRAM (SDRAM), Static RAM (SRAM), and the like), nonvolatile memory elements (e.g., Read Only Memory (ROM), Programmable ROM (PROM), Erasable PROM (EPROM), Electrically Erasable PROM (EEPROM), hard drive, tape, Compact Disc ROM (CD-ROM), and the like), or combinations thereof. Moreover, the memory device 24 may incorporate electronic, magnetic, optical, and/or other types of storage media. The memory device 24 may have a distributed architecture, where various components are situated remotely from one another, but can be accessed by the processing device 22.

The memory device 24 may include a data store, database (e.g., database 30), or the like, for storing data. In one example, the data store may be located internal to the control system 14 and may include, for example, an internal hard drive connected to the local interface 32 in the control system 14. Additionally, in another embodiment, the data store may be located external to the control system 14 and may include, for example, an external hard drive connected to the Input/Output (I/O) interfaces 26 (e.g., SCSI or USB connection). In a further embodiment, the data store may be connected to the control system 14 through a network and may include, for example, a network attached file server.

Software stored in the memory device 24 may include one or more programs, each of which may include an ordered listing of executable instructions for implementing logical functions. The software in the memory device 24 may also include a suitable Operating System (O/S) and one or more computer programs. The O/S essentially controls the execution of other computer programs, and provides scheduling, input/output control, file and data management, memory management, and communication control and related services. The computer programs may be configured to implement the various processes, algorithms, methods, techniques, etc. described herein.

Moreover, some embodiments may include non-transitory computer-readable media having instructions stored thereon for programming or enabling a computer, server, processor (e.g., processing device 22), circuit, appliance, device, etc. to perform functions as described herein. Examples of such non-transitory computer-readable medium may include a hard disk, an optical storage device, a magnetic storage device, a ROM, a PROM, an EPROM, an EEPROM, Flash memory, and the like. When stored in the non-transitory computer-readable medium, software can include instructions executable (e.g., by the processing device 22 or other suitable circuitry or logic). For example, when executed, the instructions may cause or enable the processing device 22 to perform a set of operations, steps, methods, processes, algorithms, functions, techniques, etc. as described herein according to various embodiments.

The methods, sequences, steps, techniques, and/or algorithms described in connection with the embodiments disclosed herein may be embodied directly in hardware, in software/firmware modules executed by a processor (e.g., processing device 22), or any suitable combination thereof. Software/firmware modules may reside in the memory device 24, memory controllers, Double Data Rate (DDR) memory, RAM, flash memory, ROM, PROM, EPROM, EEPROM, registers, hard disks, removable disks, CD-ROMs, or any other suitable storage medium.

Those skilled in the pertinent art will appreciate that various embodiments may be described in terms of logical blocks, modules, circuits, algorithms, steps, and sequences of actions, which may be performed or otherwise controlled with a general purpose processor, a DSP, an ASIC, an FPGA, programmable logic devices, discrete gates, transistor logic, discrete hardware components, elements associated with a computing device, controller, state machine, or any suitable combination thereof designed to perform or otherwise control the functions described herein.

The I/O interfaces 26 may be used to receive user input from and/or for providing system output to one or more devices or components. For example, user input may be received via one or more of a keyboard, a keypad, a touchpad, a mouse, and/or other input receiving devices. System outputs may be provided via a display device, monitor, User Interface (UI), Graphical User Interface (GUI), a printer, and/or other user output devices. I/O interfaces 26 may include, for example, one or more of a serial port, a parallel port, a Small Computer System Interface (SCSI), an Internet SCSI (iSCSI), an Advanced Technology Attachment (ATA), a Serial ATA (SATA), a fiber channel, InfiniBand, a Peripheral Component Interconnect (PCI), a PCI eXtended interface (PCI-X), a PCI Express interface (PCIe), an InfraRed (IR) interface, a Radio Frequency (RF) interface, and a Universal Serial Bus (USB) interface.

The network interface 28 may be used to enable the control system 14 to communicate over a network, such as the network 12, the Internet, a Wide Area Network (WAN), a Local Area Network (LAN), a public network, a private network, a Virtual Private Network (VPN), a centralized network, a decentralized network, a hybrid network, a blockchain network, and the like. The network interface 28 may include, for example, an Ethernet card or adapter (e.g., 10BaseT, Fast Ethernet, Gigabit Ethernet, 10 GbE) or a Wireless LAN (WLAN) card or adapter (e.g., 802.11a/b/g/n/ac). The network interface 28 may include address, control, and/or data connections to enable appropriate communications on the network 12.

The control system 14 further includes a content and advertisement distribution program 34. The content and advertisement distribution program 34 may be configured in any suitable combination of hardware, software, and/or firmware. When implemented partially or fully in hardware, for example, the content and advertisement distribution program 34 may be configured in the processing device 22. When implemented partially or fully in software or firmware, for example, the content and advertisement distribution program 34 may be configured in the memory device 24. Also, in the embodiments in which the network 12 is a decentralized system, the content and advertisement distribution program 34 may be embedded in multiple devices throughout the media and ad sharing system 10 for providing all or parts of the functionality described herein.

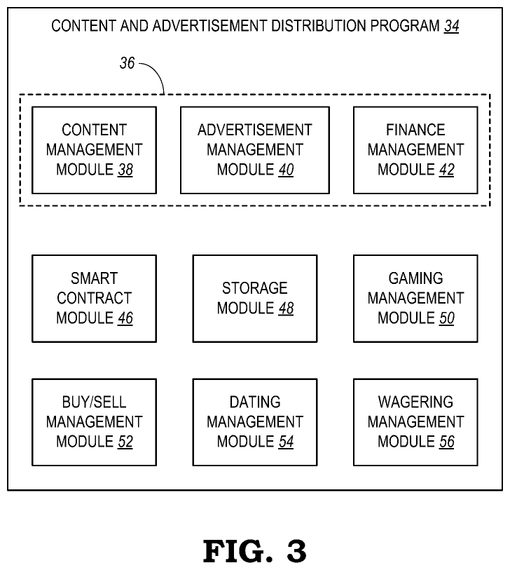

Among other things, the content and advertisement distribution program 34 may be configured to aggregate the functionality of content sharing systems with the functionality of online advertising systems. Also, the aggregation of content sharing and advertisement placement may be coordinate through financial algorithms. For example, an advertiser may pay a fee each time their ad is displayed or presented on viewing screens of the end user devices 16 for allowing the users to view the ads along with the media content. More details of the content and advertisement distribution program 34, for example, are described below with respect to FIG. 3.

FIG. 3 is a block diagram illustrating an embodiment of the content and advertisement distribution program 34 shown in FIG. 2, which may be implemented with respect to the control system 14 shown in FIG. 1. In the illustrated embodiment, the content and advertisement distribution program 34 includes at least an aggregation unit 36, which is configured to perform the preferred actions of the content and advertisement distribution program 34. That is, the aggregation unit 36 strategically combines or aggregates the advertisement systems with one or more media content sharing systems to place or embed ads within media content therein. This integration of ads within media content also includes a financial component in which advertisers pay for the ads to be placed while content providers are paid to create and share media content that is viewed by others.

In particular, the aggregation unit 36 includes a content management module 38, an advertisement management module 40, and a finance management module 42. The management of media content, advertisements, and finances may be coordinated in any suitable way. In some embodiments, managing content, ads, and finances may include the use of blockchain, Non-Fungible Tokens (NFTs), and/or other secure data recording and sharing procedures, particularly in a distributed or decentralized manner. Essentially, the content and advertisement distribution program 34 is configured to combine features of advertisement planning strategies with the sharing of digital media content, where the content and ads are presented in a specific manner and where financial transactions are processed. That is, advertisers pay for advertising while content providers/creators are financially rewarded for users consuming content that is embedded with ads or presented in conjunction with the ads.

Therefore, the aggregation unit 36 may be referred to as an “advertisement agency platform” or may be part of an advertisement agency platform. Thus, the aggregation unit 36 forms a single platform that can enable the creation, purchase, distribution, and tracking of advertisements in the network 12. The aggregation unit 36 can then oversee advertisement activity over any decentralized network or Web3 system.

The content management module 38 may be configured to coordinate how various content posts are distributed to various viewers. This may be based on an intended audience that the user can select, as described in more below. For example, a content creator may wish to simply upload a specific media post to only the user's closest friends, while other posts may be intended for more views (e.g., all the user's former classmates).

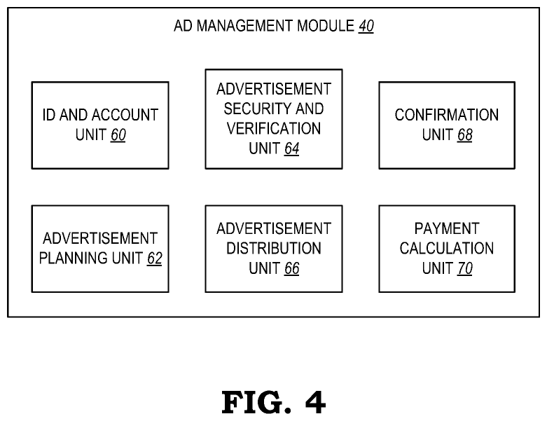

The advertisement management module 40, which is described in more detail below with respect to FIG. 4, may be configured to allow an advertiser, using one of the advertiser devices 18, to create or plan an advertisement campaign for presentation on one or more content sharing platforms associated with the media and ad sharing system 10. Again, the advertisement management module 40 may include features similar to or the same as the features described in the commonly owned patents and publications mentioned above, which are incorporated by reference herein. For example, the advertiser may create an ad, select a number of times the ad is to be presented, select an area (in which end user devices 16 are located) where the ad is to be presented, select one or more time periods when the ad is presented, etc.

The advertisement management module 40 may also be configured to determine a reasonable post/ad ratio that represents the number of media content posts that a viewer may see compared to the number of ads that are presented. As an example, this ratio might be 10:1, where ten posts are displayed for every one ad displayed. Also, the advertisement management module 40 may be configured to designate certain “ad spaces” among a number of content posts that each viewer may view. The advertisement management module 40 can then insert an ad in that ad space (e.g., among a number of posts). Also, the advertisement management module 40 can keep track of the number of times the ads are presented, viewed, clicked on, dwelled on for a certain time, etc., where this information may be encrypted in a blockchain or using other security measures.

The finance management module 42 may be configured to create smart contracts with various advertisers. One smart contract, for example, might include the distribution of an ad to be presented along with a specific (selectable type of) media content. For instance, an advertiser may wish to present an ad for a sports drink along with one or more posts where descriptions of sports or sports teams are included in the content. The finance management module 42 charges the advertisers according to the contracts based on what has been delivered. Also, the finance management module 42 can reward the content creators for providing a means by which the ad might be viewed. The finance management module 42 may be configured to take a commission or fee for the services provided, as described in the present disclosure, which may be able to provide a profit for the owner of the media and ad sharing system 10 and/or control system 14.

In some embodiments, the finance management module 42 may be configured to establish a cryptocurrency scheme that can be used for secure and private transactions and exchanges. For instance, the finance management module 42 may include a unique “coin” system that conveys value. The unique coins may be exchanged like cash for performing the various types of financial interactions described in the present disclosure.

The coin system of the finance management module 42 may include coins for different advertisement activities. For example, one coin may be used that identifies the ads created. Another coin may be used to identify ad spaces where the ads might be shown. Yet another coin may be used to identify sales transactions where ads were bought. Still another coin may be used to record the distribution of ads in the ad spaces. And yet another coin may be used to report that ads were shown and viewed.

In some embodiments, the finance management module 42 may also set fair and reasonable prices for various types of subscriptions that may be provided. For example, a content creator (e.g., influencer, celebrity, music group, organization, etc.) may provide certain content for fans or followers. These followers (e.g., content consumers using the end user device 16) can subscribe to this celebrity or group to receive special content at a certain price per month or year, for example.

In some embodiments, the finance management module 42 may also set a reasonable price for a situation referred to herein as a “celebrity request.” With a celebrity request, a follower can send a message or media content to a celebrity (e.g., with or without a subscription), along with a small fee, where, if the celebrity reads or views this comment or content, the celebrity can then receive all or a portion of this fee. This too may be monitored and controlled by the finance management module 42 for this type of transaction. Also, the celebrity may decide to respond to the fan or perform other actions. For example, if the fan provides a suggestion that the celebrity decides to use in their profession (e.g., providing a joke to a comedian), the celebrity may even create a smart contract to pay the fan for this suggestion if there is agreement from both sides. This too can be formed in a blockchain format. It should be understood that other applications in this regard can be conceived from this feature.

Thus, the aggregation unit 36 includes the content management module 38, advertisement management module 40, and finance management module 42 and is configured for aggregating ad placement and content sharing while performing financial transactions with respect to the various players (e.g., advertisers, content providers). In addition, the content and advertisement distribution program 34 may further include other features, which, in some embodiments, may be optional. For example, the content and advertisement distribution program 34 may also include one or more of a smart contract module 46, a storage module 48, a gaming management module 50, a buy/sell management module 52, a dating management module 54, and/or a wagering management module 56, each of which is described in more detail below.

The smart contract module 46 may be configured to create a smart contract (e.g., blockchain, NFT, etc.), which may be offered as a way for subscriptions to be created, when there is agreement between a publisher and a subscriber. The smart contract module 46 may also be configured to create a smart contract in a dating-type arrangement associated with the dating management module 54 to ensure that both parties agree to certain terms of potential relationships. Smart contracts can also be used as explained above, where a celebrity might agree to pay a follower a certain amount for content (e.g., movie idea, music, joke, business idea, etc.) that the celebrity might use for their profession.

The storage module 48 may be used in a similar way as a MaaS device as describe with respect to FIG. 1 for storing media content. This may include storing in the database 30 or an external database. Also, the storage module 48 may charge one or more users (e.g., using the end user devices 16) for the service of storing their content for a certain length of time (or indefinitely).

The gaming management module 50 may also be option to allow users to play digital games, either with other users or in one-person games. In online games (e.g., NFT-type games), players may exchange cryptocurrencies using the financial management module 42 and/or smart contract module 46. This allows the players to buy and sell virtual real estate, skins, weapon upgrades, loops, etc.

The buy/sell management module 52 may be used in a way to allow user to post classified ads to sell certain items (e.g., cars, computers, artwork, etc.). Also, other users may wish to purchase an item listed in the marketplace of the buy/sell management module 52. The buy/sell management module 52 may be an added feature to allow buyers and sellers to join a group to arrange certain transactions.

The dating management module 54 may be configured to allow groups of people to meet online. Users can share certain personal information and what they might be looking for in a friend, romantic relationship, etc.

The wagering management module 56 may be another optional page that a user can join. It should be noted that various forms of online gambling or betting may be illegal in some state, jurisdictions, etc., and therefore can be omitted from or unavailable for users living in these areas where this type of behavior is prohibited. Again, financial transactions may be enabled uses blockchain or NFT technologies.

Thus, a user may utilize one of the end user devices 16 to create, share, and view media content as described above. Also, the user may download or join one or more other online environments to facilitate additional user experiences, such as gaming, buying and selling, dating, wagering, (e.g., associated with modules 50, 52, 54, 56), etc. Each of these additional user experiences may also provide “ad space” where ads can be inserted. For example, in a gaming environment, ads can be placed in designated blank or neutral areas within the game. According to one example, with respect to a game in which a character enters a virtual 3D world (e.g., first-person view, second-person view, or third-person view), there may be blank areas (e.g., the wall of a building) that a player may walk or drive past, and it may be these blank areas where ads can be added. In a dating environment, according to another example, a display may show an ad among a number of potential dating profiles.

FIG. 4 is a block diagram illustrating an embodiment of the advertisement management module 40 shown in FIG. 3. As shown in FIG. 4, the advertisement management module 40 may include an ID and account unit 60, advertisement planning unit 62, an advertisement security and verification unit 64, an advertisement distribution unit 66, a confirmation unit 68, and a payment calculation unit 70.

For example, the ID and account unit 60 may allow the advertiser to create an account or for a representative to create an account for the advertiser. The user may log into an established account whenever he or she wishes to create and/or edit one or more advertisement strategies, which may also be referred to as an advertisement campaign. The ID and account unit 60 may also be configured to receive advertiser information, such as one or more cryptocurrency accounts, physical billing address, information regarding a contact person or manager, e-mail information, billing information, contact information, and other information.

The advertisement planning unit 62 enables the advertiser to create and plan how the ads are presented to the users and in which user experiences the ads are to be placed. The act of presenting the advertisement may include embedding the ad into the user experience, placing the ad in specifically designated ad spaces, and/or incorporating the ad among media content or other online elements. The advertisement planning unit 62 is configured to allow the advertiser to not only create ads, but also to develop an ad strategy. For example, the ad strategy may include time periods when the advertisement is to be run and one or more locations where the advertisement is to be run. The advertisement strategy may also include a quantity value that represents a maximum number of ads to be presented in the online user experiences.

The ad strategy, for example, may be created by allowing an advertiser to one of the advertiser devices 18 so as to electronically arrange elements of an advertisement. The advertiser can also enter a time period when the advertisement is to be run and one or more online locations (e.g., specific user experience apps and spaces within each app) where the advertisement is to be presented (i.e., for ads with pictures or videos).

In some embodiments, the advertisement planning unit 62 may include a web-based portal that allows the user to create the advertisement strategy online using a remote computer (e.g., advertiser device 18). The advertisement planning unit 62 allows multiple users to create a plurality of advertisement strategies that can be distributed to multiple ad spaces within the media content and/or other user experience environments.

When an advertisement strategy is created, the security and verification unit 64 may be configured to add security elements to the advertisement strategy, such as by creating a blockchain. An arrangement can be determined beforehand that security will include certain coding/decoding elements, certain encryption/decryption elements, etc., which, again, may be based on blockchain technology or other suitable security coding and encryption mechanisms. In this way, only the compatible components within the media and ad sharing system 10 will understand how the online apps are experienced and how the ad placement and financial reward platforms are executed. Security elements will prevent unauthorized tampering or hacking of the financial transactions as well as the ads and ad strategies.

The verification elements of the advertisement security and verification unit 64 may include ensuring that the ads include certain predetermined sizes and/or dimensions that may correspond to available ad spaces with the user experience apps. Also, the verification may include ensuring a specific resolution, specific file naming convention, and/or other specifications or security features.

The advertisement security and verification unit 64 may also be configured to automatically check for obscene or vulgar content in the advertisement. If any such content is found, the advertisement can be rejected. The automatic check may be performed by searching for profanity or other obscene, vulgar, indecent, or morally questionable language in the text portions of the advertisement. The automatic check can also look for inappropriate image features. The verification may also allow a person, such as an advertisement verifier, to visually check the content of the advertisement. In some embodiments, this may be service provided by a user of one of the end user device 16 who may wish to perform this task in exchange for NFTs, for example. Also, the ad verification check may prevent inappropriate content from being placed in advertisements that might be displayed to minors in the user experiences. For example, the visual check may include searching images and text for inappropriate content.

Also, the verification features of the advertisement security and verification unit 64 may be configured to determine whether the advertiser is a legitimate business, which may include checking with business records for a particular city, state, or country. Verification may also include running a credit check, checking a license to operate, checking phone numbers and addresses of the business, or perform other checks to determine if the entered ID and/or account information for the advertiser appears to be valid. Furthermore, verification may include analyze text in the ads and check this with predetermined words or phrases that may be considered to be offensive, vulgar, obscene, or inappropriate in any way, depending on censorship criteria for certain jurisdictions or based on the audience (e.g., minors). For example, ads related to alcohol, sex, etc. may be determined to be impermissible for general audiences and may not be approved for presentation in certain online environments.

The advertisement distribution unit 66 may be utilized when ads have been created, ad strategies have been developed (e.g., based on times, user experience apps, number of times the ads will be presented, etc.), and the ads have been secured and check for validity, the ads can then be distributed appropriately. The advertisers may select times and environments when ads are to be displayed or presented. For example, an ad for sports equipment may be presented when that certain sport is in season and may be focused on users who might normally enjoy sports (e.g., gamers who play sports-related online games). The advertisers can also select location parameters for targeting their ads to the end user devices 16 within certain areas. The advertisers can also select how many times the ads are intended to be displayed or presented (or a maximum number of times that the ads are displayed or presented).

The confirmation unit 68 may be configured to track ads and their distribution and confirm when and where the ads are presented. The confirmation unit 68 can also calculate the number of times that the ads are presented. The confirmation may include confirming whether the ads are presented according to the ad strategies (e.g., within time constraints and within the specifically requested user experiences). When it is confirmed that ads are properly presented to user in a viewable manner, the confirmation unit 68 can work with the payment calculation unit 70 to charge the advertisers the appropriate amount of money or cryptocurrency (e.g., based on the number of times the ads were presented).

The payment calculation unit 70 may calculate a quantity, which may be related to the number of times that the ads were presented, the length of time that the ads were viewable, a dwell time when the user was viewing the ad, or other measurable factors. From the quantity factor, the payment calculation unit 70 can calculate an amount that the advertiser should pay for advertising. Some factors may be used to determine if the price for advertising should be increased or decreased, such as during peak times, during important events, time of day, etc. In some embodiments, multiple advertisers may bid for prime advertising spots.

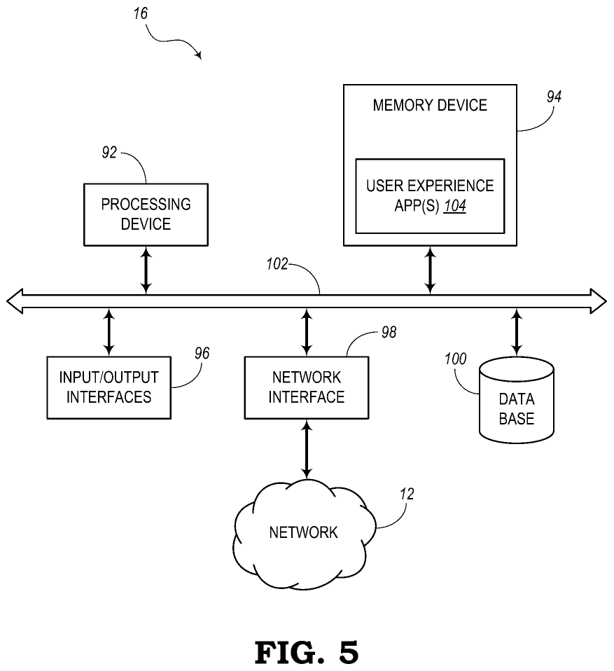

FIG. 5 is a block diagram illustrating an embodiment of one of the end user devices 16 shown in FIG. 1 that allows a user to share media content and/or consume media content. In the illustrated embodiment, the end user device 16 may be a digital computing device (e.g., computer, mobile phone, tablet, etc.) that includes a processing device 92, a memory device 94, I/O interfaces 96, a network interface 98, and a database 100. It should be appreciated that FIG. 5 depicts the user device in a simplified manner, where some embodiments may include additional components and suitably configured processing logic to support known or conventional operating features. The components (i.e., 92, 94, 96, 98, 100) may be communicatively coupled via a local interface 102. The components 92, 94, 96, 98, 100 may include the same or similar features as the corresponding components described with respect to FIG. 2. However, the end user device 16 may be used by a user for creating and posting media content and/or for viewing or consuming media content provided by other users, while the control system 14, as described above, is configured to coordinate the operations of the media and ad sharing system 10 as described with respect to FIGS. 2-4.

Furthermore, the end user device 16 includes one or more user experience apps 104. The user experience apps 104 may include content sharing apps, content viewing apps, apps for sharing digital media content, such as text, messages, pictures, videos, music, memes, and combinations thereof. In addition to media content sharing, the user experience apps 104 may also include other types of online experiences, such as gaming apps, buying and selling apps, dating apps, wagering apps, etc., which may be associated with the corresponding modules 50, 52, 54, 56 shown in FIG. 3.

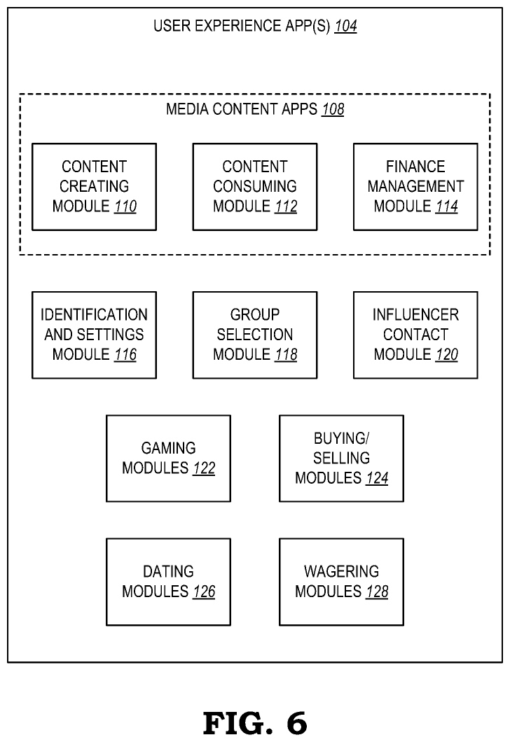

FIG. 6 is a block diagram illustrating an embodiment of the user experience app(s) 104 shown in FIG. 5. The user experience apps 104 include at least a main set of media content apps 108 including a content creating module 110, a content consuming module 112, and a finance management module 114. The content creating module 110 allow the user to create media content and upload that content to one or more social media servers or sites or to create shareable blockchain files of the created content that can be shared in a decentralized system. The content consuming module 112 allows the user to view content that others have shared on one or more social media sites or blockchain files in a decentralized manner. The finance management module 114 is configured to enable the user to see the current balance of money, coins, and tokens (e.g., fiat, crypto, etc.), particularly with respect to coins/token received for certain created content and coins/tokens paid for certain consumed content. Also, the finance management module 114 allows the user to transfer money into an account (e.g., wallet), which can be used for paying certain expenses for various user experiences. For example, the user may utilize a celebrity request function to contact a well-known celebrity or influencer (for a fee) so that the celebrity views the user's personal content.

In addition to the main set of media content apps 108, the user experience apps 104 may also include one or more of an identification and settings module 116, a group selection module 118, an influencer contact module 120, gaming modules 122, buying/selling modules 124, dating module 126, and/or wagering modules 128. The identification and settings module 116 allows a user to enter a new account, along with personal information and user settings, which can be stored securely in blockchain format.

The group selection module 118 allows the user to enter multiple groups to which content may be shared. Any one or more of the groups may be selected when content is being uploaded or shared. For example, the groups may include a) everyone (and anyone), b) closest friends and family, c) followers (in a subscription-type arrangement), d) other buyers or selling (e.g., associated with the buying/selling module 124), e) specific person or group (e.g., celebrity, influencer, music band, etc.), such as a person being identified in association with an influencer contact function related to the influencer contact module 126), special groups (e.g., club members, former classmates, church group members, etc.), and so on.

The influencer contact module 120 includes functionality to enable a user to contact a specific influencer (e.g., celebrity) to whom the user wishes to pass along a message or other content. For example, a user may wish to share an idea for a joke to a famous comedian, or a user may wish to share a business idea with a famous businessman, or a user may wish to share a new song with a famous singer. In these and other cases, the user can use the influencer contact module 120 to provide media content to that specific person or group. Along with the media content, in this situation, the user must also pay a fee for the privilege of the celebrity taking the time to review the content. On the end user device 16 associated with the celebrity, the celebrity can select to review the content (e.g., see the artwork, listen to the song, read the joke, etc.). When it is confirmed that the celebrity reviews or comments on the content, the payment is made to the celebrity for acknowledging the follower's content. The finance management module 114 may be configured to arrange the processing of the payment, which again can be done through blockchain, NFT, or other secure transaction.

The gaming modules 122, buying/selling modules 124, dating module 126, and wagering modules 128 may also be included in the user experience apps 104. These allow the user to interact with other online for playing games, buying or selling items, sharing online dating profiles, betting or gambling on sports or other games of chance (where legal), etc. In addition to the normal operations of these apps, the control system 14 is configured to embed ads within available ad spaces.

The finance management module 114 may be configured as a wallet or coin (e.g., crypto) system for individual users. The users can publish their own content on a decentralized system that has an ad system (e.g., advertisement management module 40) built in. The finance management module 42 corresponding to the content and advertisement distribution program 34 of the control system 14 is configured to communicate with the corresponding finance management modules 114 of each of the end user devices 16 to conduct financial transactions safely and securely across the media and ad sharing system 10. With agreement from both sides, the control system 14 may utilize its smart contract module 46 to create a contract or agreement that defines various terms of the transactions.

For example, based on the number of times that media content (from a content creator) is viewed, scanned, etc. and/or based on the number of times that the content consumers “like,” comment on, or respond in some other way, the finance management module 42 is configured to pay the content creator a certain amount of money, digital coin, tokens, NFT, etc. Also, the finance management module 42 collects money (e.g., fiat, cryptocurrency, etc.) from the advertiser devices 18 when ads are run (e.g., embedded in the media content). Also, the finance management module 42 may keep a certain amount of money for overhead costs and profits for the services provided to content creators, content consumers, advertisers, game developers, gamers, daters, gamblers, and others using or experience the various apps described herein.

In some embodiments, some users may wish to store personal data in the memory device 94 or database 100 using the respective identification and settings module 116 or stored in a “wallet” associated with the finance management module 114. Then, the users can share this information or money with those they choose, such as to purchase items using the buying/selling modules 124, purchase runes, loops, skins, etc. using the gaming modules 122, to contact a celebrity using the influencer contact module 120, to purchase lottery tickets, play games of chance, or gamble using the wagering modules 128. Also, in some embodiments, the user may wish to give a “tip” or “donation” to one or more users when he or she finds the viewed media content exceptionally entertaining or useful, to reward artists or musicians who provide entertaining art or music, to act as a patron of an artist or musician, and the like.

On a public side, the users can share pictures, videos, comments, etc. with the entire world or with specific groups as defined by the group selection module 118 at any time that content is shared. This too can be performed through the wallet (e.g., finance management module 114). The users can also place ads to sell a car, sell photos or videos of themselves, or sell NFT's. Thus, the entire media and ad sharing system 10 may be monetized to allow users and the developer of the control system 14 to make a profit through ad sales and commissions on exchanges made.

To incentivize users from the very beginning, every user may easily download an app from the control system 14 to enable the decentralized sharing of media content with the financial reward system and may immediately use the site to share content and receive a share of the profits from ads inserted along with their content. Even if that user only has one post, he or she can make money when other view it, since ads can be added with the content. Also, when users interact and money is exchanged, the control system 14 uses its finance management module 42 to take a small commission or fee.

The control system 14 may include elements similar to other web-based social media sites. However, the control system 14 is configured to be distributed on the network 12 and may be configured in a blockchain form of distribution. The control system 14 may provide software and/or firmware to the user devices 16 to offer users the ability to make a profile by sharing messages, posts, pictures, videos, updates, location-based updates, etc. Also, the control system 14 may provide software and/or firmware to the advertiser devices 18 to allow advertisers to advertise within available virtual space or real estate within social media content sharing pages, within PVP games, within dating sites among potential dating profiles, and so on.

The end user devices 16 may include a wallet/viewer element. The users can enter in their information and anything they wish to share with friends or family. The users can also set permissions for all data so they can decide who gets to see what. These permissions can be revokable by making the viewability determined by a third element, such as friend status.

All the data (e.g., media content) can be saved on the decentralized system using MaaS devices, such as Arweave or other suitable system. In some embodiments, the media and ad sharing system 10 may use newgroups, torrents, personal servers, and/or traditional servers to serve content. When another user tries to access the data through his wallet/viewer, his permissions are verified and, if allowed, he can download and view the content.

The financial records may all be kept safe within blockchain or other suitable digital ledger system. Also, ads created by the advertisers can be placed on blockchain data, as well as identifiers and security elements. To place ads on decentralized data, the media and ad sharing system 10 is configured to create an identifier or token for the ad space and for the content creator. Each ad space token can reach out to an ad server (e.g., advertisement management module 40) of the control system 14 to ask for an ad to display. The ads may be sold with regard to the characteristics of the viewer as well as the content on the page. They can be purchased and designed to only be displayed at certain dates or time or locations as well as to be displayed based on certain characteristics of the viewers. In some embodiments, the users can opt into characteristic ad serving, or get more generic ads. Also, in some embodiments, users can “subscribe” to get an ad free experience on the platform for a fee.

Content providers can make thousands of dollars with popular channels or subscription on social media sites, and even more can be made with a patron account (e.g., Patreon, onlyfans, etc.). The media and ad sharing system 10 is configured to combine attributes of both media content sharing with advertising into one platform in the wallet/viewer. This allows the users to post content for free and allows them to sign up viewers for exclusive content as well. Ad revenue can be shared with these content providers from day one. Ads can be placed with their content and money can be made on short messages, pictures, videos, or anything that the users may wish to post.

Users may interact through the wallet/viewer on the end user device 16, which may be a computer (e.g., personal computer, laptop, tablet, etc.) and/or mobile device (e.g., smart phone, cell phone, etc.). These can be viewed like any website or app but may be self-contained. Users may download an app, wallet, or web browser extension from the control system 12 and may create a profile within this wallet (e.g., using the identification and settings module 116). The users can then select who gets to see their info and who does not, such as by accessing the group selection module 118. For example, in some scenarios, the user can set the exposure to “everyone” (or the entire Internet) if they wish to share with anyone. They may also set the exposure such that the content is viewable by only certain people or certain groups, like friends etc. All items in the profile and all content can be segregated by who gets to see what.

In some embodiments, the identification and settings module 116 may be used for various types of identification. This module 116 could be used for storing a copy of a passport or other documentation in the memory device 94 or database 100 in a secure manner. Also, personal information can be stored using a password manager.

The finance management module 114 may be configured as a crypto payment system, which may have similarities to the Google pay system. In some embodiments, a profile page may be created from the identifying information from the identification and settings module 116. This profile page may be shared with only certain people, which may include one or more groups selected in the group selection module 118, such as close friends and family only, and/or may be shared in certain dating apps accessible through the dating modules 126. Other profile pages may be created and shared with other selected groups, as the user may desire.

The wallet may also include secure information, such as health records, test results, prescription records, etc. This information may only be accessible (based on the user's discretion) to a medical team, which might include doctors, nurses, medical staff, family members, or other responsible people.

Another section can be using for storing profile information for use the dating modules 126. In some cases, this section may include health and consent information and agreements to help prevent the spread of communicable diseases and to provide a bases for content information about potential or ongoing relationships (e.g., for legal purposes). A user may use the dating modules 126 to share a profile for dating, which can be shared with everyone or with certain selected groups of people. The user may select what items they wish to share (e.g., photos, general location, general identifying characteristics, romantic interests, etc.). In some embodiments, the dating modules 126 may track communicable diseases to warn people if they had been in contact with someone who may have contracted a disease (as applicable with respect to HIPAA laws) for the purpose of helping to prevent the spread of diseases.

The media and ad sharing system 10 may use a platform coin for platform payments, which can be convertible to other coins. The media and ad sharing system 10 may pay in a new dedicated coin or native tokens or NFT for ads that are sold. When financial transactions are conducted (e.g., a user buying a picture, etc.), the finance management module 42 may be configured to require them or offer them the opportunity to buy the new dedicated coin or native tokens or NFT to conduct transactions.

According to one particular application of the media and ad sharing system 10, a user may be in an area where a special event is taking place, such as a natural storm, an automobile accident, etc. In these events, the user might be fortunate to capture a video or images of the incident, which may be news worthy. In this situation, the user may create original news content in their area and make money by sharing this with a local audience, national audience, or worldwide. In some embodiments, a news organization may pay the user for this content.

Aside from revenue sharing, the media and ad sharing system 10 can allow for “tipping” when people find content valuable. Tipping can be for any content, not just news, but this may encourage locals to report on news worthy happenings in their area. The user can record video and/or audio of the incidents and post the content to get money for views. They can contract to sell their videos for republishing by local or national news agencies within the platform NFT or the like. This may be referred to as “citizen journalism.” In this way, regular contributors can help share news events and can be shared with other active channels. Also, a viewer may click on a map (or receive push notifications of local news) to see news in specific areas and/or may wish to see hotspots where many events are taking place to see in real-time what is going on. The news can be short messages, videos, pictures, stories, commentary, or other type of information that can convey the news events.

Regarding data retention, data can be stored by any suitable decentralized means, such as a service like Arweave or other services that may be created. While Arweave may be related to retaining data indefinitely, content creators might want to delete or change what users can see. Also, some items may have few views and have little practical value to keep and therefore the creator might not care enough to warrant keeping it. The media and ad sharing system 10 may include a system where data can be kept for a period of time, but if the creator wants to keep it longer or forever (indefinitely), or if other users or viewers want to archive it, they can pay to archive the data. It can be paid by a group, where, say, hundreds or thousands of viewers may agree to pay say a small amount (e.g., a penny) towards its forever retention.

Regarding the influencer contact module 120, this module 120 may include a verified read message function. For example, many people may wish to contact a celebrity, famous person or business man, etc. With the media and ad sharing system 10, a blockchain smart contract can be created by the smart contract module 46. In one example, a follower can send a message or media content to a celebrity, who may then read or view the message or media content. Upon confirmation that the celebrity (influencer) opens the message, views it, scrolls through it, clicks on some response, and/or provides some sort of indication that the message or media content has be viewed, considered, read, etc., the reader (celebrity) completes his duty and is paid an amount of coin. Funds can go to the reader or can be designated to a third party, such as a charity or a fund-raising event.

Therefore, according to various embodiments, the media and ad sharing system 10 may be a decentralized system, a centralized system (e.g., controlled by the control system 14), or any other type of system. More particularly, however, the media and ad sharing system 10 is configured to use blockchain, NFT, cryptocurrency, digital coins, digital tokens, etc.

Blockchain can be used to determine who and how many people are viewing a streamed item. Blockchain, cryptocurrency, coins, tokens, and the like can allow the importing of functionality of other media sharing programs for use in the financial sharing ecosystem of the present disclosure. Blockchain etc. may also:
allow adding access to features from a decentralized platform to a wallet to bring functionality to other wallets or viewers;
allow users to set attributes, turn on and turn off viewing rights to certain elements they have created;
record agreements regarding romantic consents;
track potential health concerns, such as communicable diseases and notifying users of the potential health concerns;
track viewers for ad purposes;
identify ad spaces or virtual real estate where ads can be shown or placed;
perform calls to ask for ads to be placed in the available spaces;
identify ads in electronic form;
incorporate identification features into an electronic ad;
incorporate, into ads, characteristics such as times and dates when the ads should be shown;
incorporate into an ad characteristics such as to be shown or displayed at a single location, a multitude of specified locations or locations that are a certain distance from a known location;
pull ads into predetermined spaces;
verify that ads have been placed;
verify that ads were viewed or were viewable;
track the number of times each ad has been viewed;
track the locations and times that ads were viewed;
identify ads and count the number of viewers and their attributes;
enable share fees or commissions to be automatically given or taken from any specified type of transaction;
enable users and content creators to see the number of ads shown on their content as well as their income from those ads;
enable users and content creators to see the number of ads shown on their content as a whole, and or see the ads on each item of content as well as their income from those ads but also showing the income from the company, and the cost or approximate cost of hosting the content;
enable user to determine income for an ad and how it is distributed to content providers upon viewing;
port data through another blockchain, token, coin, or other element to act as a VPN;
handle data in a way to hide the originating wallets and/or users;
delete files after a period of time;
create a smart contract where, upon certain verifiable events that indicate a message was received and read, the contract is fulfilled and payment is made to the reader; and the like.

Also, the blockchain may act as a VPN to view data via a crypto wallet where data is run through one or more intermediaries, so it is unknown who the final recipient is. Also, the media and ad sharing system 10 may notify a sender about a smart contract to inform the sender when his or her message was read by the celebrity or influencer. Also, the media and ad sharing system 10 may set up or create a fundraiser so that “readers” that are celebrities can donate payments for reading to a fundraising event. Also, the system 10 may include a function where a person who is to receive payment for fulfilling a contract can assign all or partial funds to a third party, such as a charity.

In some respects, the media and ad sharing system 10 may include similarities to websites and social media sites. However, the media and ad sharing system 10 may be configured using blockchain to enable the decentralization of the system. For example, the media and ad sharing system 10 may be part of a system referred to herein as an advertisement agency for Web3. For example, the ad agency system of the present disclosure may include Web3 features, which may incorporate decentralization, blockchain technologies, token-based currency, etc. It may be noted that the implementation of the present embodiments in a Web3 network are able to keep advertising, gaming, social media, etc. from centralized Big Tech to allow decentralized freedom for user. Also, the present embodiments may be incorporated in a decentralized system (e.g., Web3) in order to increase data security and maintain user privacy. The decentralization of Web3 for enabling the advertisement agency platform described in the present disclosure enables the creation of an online ecosystem based on cryptocurrency and blockchain security.

Blockchain technology can be used to create smart contracts to automate payments in a decentralized manner. Also, the system 10 in some cases may provide a greater financial reward and a quicker payment schedule that other sites. Thus, artists and musicians may benefit from greater financial rewards who spend a lot of time practicing their craft for the enjoyment of others. The system 10 combine the content sharing functionality with the advertising functionality and applies a financial reward system for people who post a lot of content and get a lot of traffic, hits, views, etc. Content providers can see their account and money received immediately after viewers consume the content.

Another aspect of the present disclosure is that ads can be applied within the gaming environments. In gaming, users buy NFTs to claim elements (e.g., land, skins, bars, skills, weapons, etc.) in the games. In the various available spaces, ads can be distributed. The system can also have an NFT billboard where players can “walk” past. The system 10 can then track and distribute spaces and ads within these games.

After the content sharing, advertising, and financial reward aggregation, the system 10 is also configured to allow each user to create multiple groups of people to whom a user might share media content. These groups, for instance, may include 1) everyone, 2) all one's mutual friends, 3) a group of one's closest friends and family members, 4) dedicated groups (e.g., classmates, former classmates, church friends, club members, etc.), 5) followers (in a subscription sense), 6) celebrities who one wants to contact, 7) a medical or healthcare group (e.g., doctors, pharmacists, family members, intimate partners, etc.), etc. Again, these groups may be recorded using blockchain, smart contracts, NFTs, etc. for grouping people into categories, with each category having different privileges. As an operator (e.g., leader, celebrity, influencer) of some groups, a user may be able to adjust a person's category or have the category permission expire as in a contract expiration.

With the “citizen journalism” feature, users are enabled to post news items for a local audience, worldwide audience, etc., which might reward the average citizen who happens to be in the right place at the right time. The news content could be picked up (and paid for) by some news agency, maybe with a smart contract. This too might automate creating distribution. Users can upvote various “important” stories to increase the value of the post, which can make the story more likely to be viewed by others. News may be searchable by location. In some embodiments, the finance management module 42 may be configured to delay the payment of certain big news stories (or other significant content sharing situations). The reason for this may be to avoid any conflict that may arise over the legitimate originator of certain content and properly rewarding users for viral videos, etc. For example, the delay may be for about 30 days or so, depending on the potential value of the content. Therefore, if someone copies a post from another person, the originator may be able to prove originality (e.g., based on the blockchain information). The finance management module 42 may hold the money until it can be verified if content was copied and then distribute money to the original creator as appropriate.

Again, regarding the influencer contact module 120, a follower (or fan) of a celebrity, music band, organization, etc. might send content (e.g., comment, suggestion, etc.) to the celebrity along with some type of payment. Then, if the celebrity reads, reviews, looks at, listens to this content from the fan, they will receive that payment. For instance, a user may come up with a business idea for a businessman or a joke for a comedian and can contact the businessman or comedian to share the content. Since the content may be protected in blockchain to clearly define the originator of the content, the influencer or celebrity could not simply steal the idea. If the businessman or comedian reviews the content and likes it, the two parties may be able to construct a smart contract for offering to pay the fan a certain amount to purchase the business idea or joke or to reach some type of financial arrangement.

A user may upload their content (e.g., piano playing video, a picture of the Grand Canyon, etc.). Anything that is upload may be recorded in a blockchain. If it is viewed by other users, it generates ad revenue based on the number views, likes, comments, etc. The created content may be assigned an NFT and may create a contract for others to see and use themselves. The elements of that contract can have variables set by the control system 12, a site owner, or by users/creators. When the content is viewed and optionally revenue generated, that share goes into their account. The NFT or the content is tracked by blockchain. The advertisement management module 40 works in the background and presents ads on the applicable platform within the ad spaces defined by NFT elements (e.g., like real estate). The ads themselves can be tracked, the contracts for distribution can put the ad NFT into the ad space NFT, completing an element of the contract allowing for payment for that view.

Content creators can be paid based on “likes,” views, time that people watch or dwell on the content item without scrolling past it, responding to the content (e.g., by clicking on a heart icon, clicking on a “more data . . . ” icon, adding a comment, etc.). There may be other options as well. It could be just per view or views that generated ad revenue and/or it could have a bonus for likes, shares, etc. With sharing, revenue can also be shared as well based on algorithms that will attempt to be fair for all parties, does not exploit the users who share less content, and may be tunable by the finance management module 42.

The finance management module 114 of each user device 16 may be able to display the user's account balance upon demand. Since there may be a large amount of money/coin transfers in the present disclosure, the finance management module 114 may include a user interface, such as a gauge or other display to show the user (e.g., particularly content consumers) how much money they have in their “account.” They might enjoy contacting various celebrities, subscribing to multiple subscriptions, etc. and might need to replenish their funds when they run low. Each user may have a “wallet” associated with the finance management module 114. In that wallet, the user can track their funds like a bank account. They can deposit money into this account and the money they make through sharing can be put into the account. The money spend on various purchases can be shown as debits. The wallet might be controlled by the individual user experience apps 104 or corresponding sites or might be somewhat generic and able to interact with multiple sites.

It should be understood that the routines, steps, processes, or operations described herein may represent any module or code sequence that can be implemented in software or firmware. In this regard, these modules and code sequences can include commands or instructions for executing the specific logical routines, steps, processes, or operations within physical components. It should further be understood that two or more of the routines, steps, processes, and/or operations described herein may be executed substantially simultaneously or in a different order than explicitly described, as would be understood by one of ordinary skill in the art.

The implementations described herein represent a number of possible implementations and examples and are not intended to necessarily limit the present disclosure to any specific implementations. Instead, various modifications can be made to these implementations as would be understood by one of ordinary skill in the art. Any such modifications are intended to be included within the spirit and scope of the present disclosure and protected by the following claims.

Although the present disclosure has been illustrated and described herein with reference to various embodiments and examples, it will be readily apparent to those of ordinary skill in the art that other embodiments and examples may perform similar functions, achieve like results, and/or provide other advantages. Modifications, additions, or omissions may be made to the systems, apparatuses, and methods described herein without departing from the spirit and scope of the present disclosure. All equivalent or alternative embodiments that fall within the spirit and scope of the present disclosure are contemplated thereby and are intended to be covered by the following claims.

What is claimed is:

1. An end user device comprising:
a network interface configured to enable communications over a network;
a processing device; and
a memory device configured to store computer logic having instructions that enable the processing device to perform the steps of:
monitoring user activity output based on operation of one or more user experience applications,
obtaining an advertisement,
securing the advertisement to the user activity output using one or more blockchain technologies to generate a secured data packet, and
distributing the secured data packet over the network via the network interface.

2. The end user device of claim 1, wherein the network includes aspects of one or more of a decentralized network, a centralized network, a hybrid centralized/decentralized network, and a Web3 network configured to maintain user privacy.

3. The end user device of claim 1, wherein the instructions further enable the processing device to perform the step of utilizing a content and advertisement distribution program associated with a remote advertisement agency platform configured to create, purchase, and track advertisements.

4. The end user device of claim 3, wherein the remote advertisement agency platform is configured to establish a cryptocurrency coin system in which coins are exchanged based on one or more of a) an identification of one or more ads created, b) an identification of ad spaces where the one or more ads are shown, c) an identification of sales transactions where the one or more ads were bought, d) a record of the distribution of the one or more ads in the ad spaces, and e) a report that the one or more ads were shown and viewed.

5. The end user device of claim 1, wherein the network interface is configured to communicate over Transmission Control Protocol and Internet Protocol (TCP/IP), and wherein the secured data packet generated using the one or more blockchain technologies is communicated over TCP/IP.

6. The end user device of claim 1, wherein the one or more user experience applications include one or more programs for enabling a) the creation of ads, b) the creation of media content, c) the playing of online games, and/or d) the participation in online wagering.

7. The end user device of claim 6, wherein the one or more user experience applications include at least a financial management module configured to conduct financial transactions related to the one or more programs for enabling a) the creation of ads, b) the creation of media content, c) the playing of online games, and/or d) the participation in online wagering.

8. The end user device of claim 1, further comprising a display device for displaying at least digital media content and advertisements.

9. The end user device of claim 1, wherein the end user device is one of a personal computer, a laptop computer, a tablet computer, a mobile phone, and a Virtual Reality (VR) system.

10. The end user device of claim 1, wherein the user activity output includes creating and sharing digital media content.

11. A control system comprising:
a network interface configured to enable communications over a network;
a processing device; and
a memory device configured to store a content and advertisement distribution program having instructions that enable the processing device to perform the steps of:
monitoring user content;
obtaining an advertisement from an advertiser;
securing the advertisement to the user content using one or more blockchain technologies to generate a secured data packet; and
distributing the secured data packet over the network via the network interface.

12. The control system of claim 11, wherein the network includes aspects of one or more of a decentralized network, a centralized network, a hybrid centralized/decentralized network, and a Web3 network configured to maintain user privacy for a plurality of end user devices operating thereon.

13. The control system of claim 11, wherein the content and advertisement distribution program allows the control system to act as an advertisement agency platform configured to create, purchase, and track advertisements from one or more advertisers.

14. The control system of claim 13, wherein the instructions further enable the processing device to establish a cryptocurrency coin system in which coins are exchanged based on one or more of a) an identification of one or more ads created, b) an identification of ad spaces where the one or more ads are shown, c) an identification of sales transactions where the one or more ads were bought, d) a record of the distribution of the one or more ads in the ad spaces, and e) a report that the one or more ads were shown and viewed.

15. The control system of claim 11, wherein the instructions further enable the processing device to receive input from the advertiser, the input including one or more of a) time parameters defining times when the advertisement is to be displayed or presented, b) location parameters for targeting the advertisement to end user devices within certain areas, and c) quantity parameters defining a maximum number of times that the advertisement is to be displayed or presented.

16. A method comprising the steps of:
monitoring user activity output based on operation of one or more user experience applications;
obtaining an advertisement;
securing the advertisement to the user activity output using one or more blockchain technologies to generate a secured data packet; and
distributing the secured data packet over a network that includes aspects of one or more of a decentralized network, a centralized network, and a hybrid centralized/decentralized network.

17. The method of claim 16, wherein the network enables communication using Transmission Control Protocol and Internet Protocol (TCP/IP), and wherein the secured data packet generated using the one or more blockchain technologies is communicated over TCP/IP.

18. The method of claim 16, wherein the user activity output is related to one or more user experiences for the creation of ads, the creation and sharing of digital media content, the playing of online games, and the participation in online wagering.

19. The method of claim 18, wherein the one or more user experiences are related to at least a financial management module configured to conduct financial transactions related to the one or more user experiences for the creation of ads, the creation and sharing of digital media content, the playing of online games, and the participation in online wagering.

20. The method of claim 16, further comprising the steps of:
tracking the secured data packet in which the advertisement is secured; and
calculating the number of times that the advertisement was displayed or presented.
